(19) United States
(12) Patent Application Publication
(10) Pub. No.: US 2014/0223578 A1
(43) Pub. Date: Aug. 7, 2014

(54) SECURE DATA DELIVERY SYSTEM

(71) Applicant: RAF TECHNOLOGY, INC, Redmond, WA (US)

(72) Inventor: David Justin ROSS, Redmond, WA (US)

(73) Assignee: RAF Technology, Inc, Redmond, WA (US)

(21) Appl. No.: 13/759,245

(22) Filed: Feb. 5, 2013

(51) Int. Cl. G06F 21/60; G06F 21/31; G06F 21/30

(52) U.S. Cl. CPC G06F 21/60; G06F 21/30; G06F 21/31
USPC 726/28

(57) ABSTRACT

A secure data provider controls access to one or more data sources on behalf of a requesting party. A negotiated query is transmitted to one or more of the data sources associated with the request based, at least in part, on the information being requested. The response to the query is modified based, at least in part, on an authorization level of the requesting party, and the modified response is transmitted to the requesting party.

### COPYRIGHT NOTICE

© 2012 RAF Technology, Inc. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This invention pertains to authenticating or verifying the identity of persons, objects, documents, databases, data streams, and other objects, to determine a level of confidence that a target is in fact what is purports or appears to be.

### BACKGROUND OF THE INVENTION

Systems that employ security measures to protect proprietary or confidential information may include an authentication of a person or entity that is requesting a service and/or information. For example, many online verification systems comprise two parts: establishing the existence of an identity that is allowed to perform the transaction, and establishing that the present requesting party has that identity. A common method for establishing the existence and content of the online identity claimed by the requesting party is to ask the requesting party for personal information items that are presumed to be known by him and by the system but by no one else.

Authentication (e.g., of the person's identity) may be performed through recognition of the person, shared knowledge, and/or possession of a private key or token.

Authentication of a person involving recognition may include reviewing and/or sharing a driver's license card; a birth certificate, or biometric information, such as a fingerprint, a voiceprint, a retinal scan, and/or other personal information.

When authenticating using shared knowledge, the system knows things about the subject that should not be common knowledge. When the subject demonstrates that he also knows these things, identification is achieved. The shared knowledge may include name, address, telephone number, drivers license number, social security number, checking account number, credit card numbers, mother's maiden name, and/or other information which tends to be static over time.

Shared information may also include variable information such as the amount of a checkbook or credit card transaction, the holder and amount of a mortgage, a credit rating, a bank balance, and/or other information which may vary from one month to the next.

Passwords are a form of both shared information and a private key. The parties of a transaction know the password, and knowledge of the password is typically restricted between the parties.

An authentication system based on shared information is more convenient and/or less expensive for the subject as compared to those based on passwords and recognition, but it can be more invasive of privacy since the requesting party must share private information with one or more other parties.

The security of an authentication system and its obtrusiveness into privacy are inversely related—the more secure the system, the harder it is to make it unobtrusive. The security needs of both the nation and the individual citizens must always be balanced against the requirement to preserve a free and open society.

One of the difficulties inherent in the authentication system is that the “private” data of the requesting party must be revealed to the authenticator so the authenticator can compare it with its file of authenticating information. Additionally, the authenticator had to get that data from some other source who gathered the data in the first place in order to authenticate it. Accordingly, the “private” data passes through, or is shared by, a number of parties prior to its being used for authentication, which provides more opportunity for the information to be obtained by undesired parties. Requesting parties, therefore, are increasingly reluctant to release private information in the first instance. In addition, since the number of information items that are both available from those other sources and of sufficient privacy, uniqueness, and appropriateness is limited and very difficult to extend, reliable authentication by this method gets more difficult with time.

The need remains for improvements in authentication of a wide variety of target objects, and for the controlled dissemination of information associated with an authenticated transaction.

### SUMMARY OF THE INVENTION

The following is a summary of the invention in order to provide a basic understanding of some aspects of the invention. This summary is not intended to identify key/critical elements of the invention or to delineate the scope of the invention. Its sole purpose is to present some concepts of the invention in a simplified form as a prelude to the more detailed description that is presented later.

The current invention is directed to authenticating or verifying the identity of persons, objects, documents, databases, data streams, and other objects, to determine a level of confidence that a “target” is in fact what is purports or appears to be, and to control the dissemination of information associated with an authenticated transaction. Examples are provided herein of systems which are configured to protect the integrity of a source of confidential information while still providing restricted information that is required to complete the transaction. The system may be used to authenticate not only the person/entity requesting the information, but also to authenticate the source of the information so that all parties to the transaction are mutually authenticated. Such multiple forms of authentication can be used individually or as part of an overall secure data access system.

Additional aspects and advantages of this invention will be apparent from the following detailed description of preferred embodiments, which proceeds with reference to the accompanying drawings.

### BRIEF DESCRIPTION OF THE DRAWINGS

FIG. 1 illustrates an example system that may be used for authentication during a transaction between a requesting party and a service provider.

FIG. 2 illustrates a process of authentication.

FIG. 3 illustrates an example system that may be used for providing secure information to a requesting party.

FIG. 4 illustrates a process of providing secure information to a requesting party.

FIG. 5 illustrates a system configured to provide secure information to a requesting party.

FIG. 6 illustrates a system configured to provide both authentication services and secure information transaction services.

### DETAILED DESCRIPTION OF PREFERRED EMBODIMENTS

Most governmental or private-sector institutions manage and control their data using one or more databases and/or servers. Access to the data may be restricted according to the recognition of a person or entity as being associated with a particular class of requesting parties, for example, internal personnel, external personnel, officers, managers, employees, contractors, customers, patients, and/or other types of requesting parties. Different levels of access may be provided to the different classes, respectively. Some classes of requesting parties may have access to a first database, but not a second database. Similarly, access to information stored on the same database may be selectively restricted based on the recognized class.

Within any one organization, particularly large governmental agencies, data may be distributed into different systems, each system having a different database and/or a different recognition hierarchy. The plurality of databases may be maintained as “stove-pipe” systems, with each system incapable of readily communicating to, and/or sharing information with, the other systems. While stove-piped systems may provide some protection against information theft and cyber attacks (limiting the amount of information that is available if the attack is successful), they are also unable to readily transfer helpful information to each other.

Examples of systems that are stove-piped include the retention of tax information at multiple sites of the Internal Revenue Service and governmental law enforcement databases. Similarly, private companies who specialize in financial credit score ratings maintain separate databases of personal financial information that may or may not correlate for any one given individual. For example, the databases don't know about each other and do not compare the information they have with each other.

When performing a transaction, requesting a service, or making an inquiry, the requesting party may provide information related to the transaction, request, and/or inquiry. In addition to authenticating the requesting party, the system may also need to authenticate the information that is provided, the levels of access allowed for the requesting party, the areas covered by each database, the databases themselves, and/or other components of a working system.

A private key may be used to authenticate that a particular request comes from a particular requesting party. However, the private key may not be helpful to initially establish the requesting party's identity. Similarly, the use of a password does not necessarily indicate the identity of the requesting party. Rather, typically the identity must be provided at the time the password is issued. In addition, if one or both of the private key and password become lost or compromised, it may require starting the authentication process over again to replace them.

Embodiments described below may be useful both for initially establishing the identity of a requesting party and for extending that initial identification to subsequent transactions. Additionally, private information associated with the requesting party may be used without revealing that private information to anyone beyond those who already had that information. Further, such information may be exchanged among parties whose existence and/or identity are not known to each other.

During an electronic transaction, the system may be configured to initially authenticate the identity of the requesting party. Once authenticated, the identity of the requesting party may be used to determine an authorization level, such as that associated with the ability to access confidential information.

A third party may be used to gather information on the requesting party, prior to the transaction. Examples of a third party would be an employer who obtains information on a new employee, or a utility company who knows the amount of a requesting party's most recent electric bill.

An authentication provider may ask the requesting party for the amount of his most recent electric bill, and then confirm the amount with the third party utility company. One or more types of personal information may be confirmed by a number of third parties in order to authenticate the requesting party, without sharing the information with any third party who previously did not have access to the information. The personal information may include a social security number, a driver's license number, age, a mother's maiden name, an address, other types of personal identification, and/or any combination thereof.

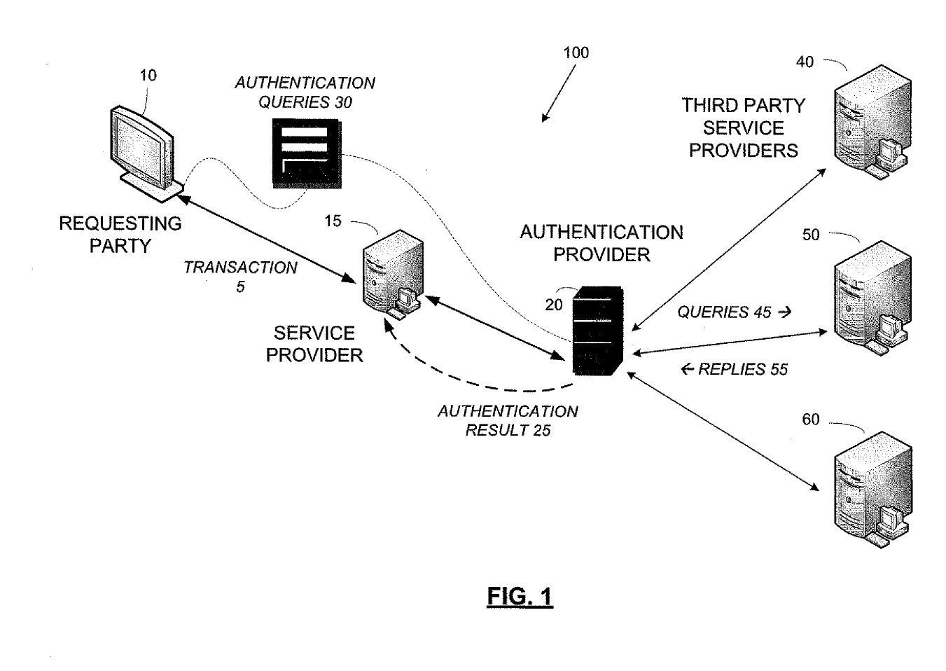

FIG. 1 depicts an example system 100 that may be used for authentication during a transaction 5 between a requesting party 10 and a service provider 15. Additional authentication systems are described in U.S. Pat. No. 7,676,433, which is commonly owned by the assignee, and which is incorporated by reference in its entirety.

The authentication process may comprise two separate stages. In a first stage, the system 100 may be configured to establish the authentication credentials of the requesting party 10 and provide one or more tokens to facilitate future transactions with the service provider 15. In a second stage, which may occur much later in time than the first stage, the requesting party 10 may utilize one or more of the tokens as part of a request for information.

In the first stage of the authentication process, the requesting party 10 submits a request for the service provider 15 to provide information, merchandise, money, and/or some other type of service associated with the transaction 5. The service provider 15 may be a commercial vendor, an on-line vendor, an e-commerce provider, a financial institution, a governmental agency, a library, a corporation, a utility, a hospital, or any other service provider. In some embodiments, the transaction 5 may be conducted, at least in part, over the Internet; however, the transaction may also be conducted over other types of public and/or private networks, including any combination of wired and wireless networks.

The service provider 15 may act as an intermediary party between the requesting party 10 and an authentication provider 20. For example, the service provider 15 may contract with the authentication provider 20 to provide authentication services as an initial step of the transaction 5, and prior to any exchange of information, merchandise, money, and/or service between the requesting party 10 and the service provider 20. In other embodiments, the service provider 15 may be integral, or combined, with the authentication provider 20, such that one entity performs functions associated with both the service provider 15 and the authentication provider 20.

In response to receiving the request to participate in the transaction 5, the service provider 15 may contact the authentication provider 20 in order to initiate a process to authenticate the requesting party 10. The authentication process may include the authentication of an identity of the requesting party 10 and/or the authentication of information provided by the requesting party 10. As part of the initial contact, the service provider 15 may provide the name of the requesting party 10, an identification number, an account number, and/or other type of identifier.

Based on the identifier provided by the service provider 15 and/or based on a type of service associated with the service provider 15, the authentication provider 20 may generate one or more queries, referred to hereafter as queries 45. The queries 45 may include requests for authenticating information. The queries 45 may be transmitted from the authentication provider 20 to one or more third party service providers, such as service provider 40, service provider 50, and/or service provider 60.

In response to receiving the queries 45, the third party service providers 40, 50, 60 may transmit one or more replies, referred to hereafter as replies 55, back to the authentication provider 20. The third party service providers 40, 50, 60 may not be aware of the identity of the service provider 15 associated with the transaction 5, such that the transaction 5 may be conducted anonymously.

The authentication provider 20 may generate one or more authentication queries, referred to hereafter as authentication queries 30, based on the replies 55. For example, the authentication queries 30 may ask the requesting party 10 to provide answers that match the information contained in the replies 55. The authentication queries 30 and answers may be transmitted directly between the authentication provider 20 and the requesting party 10 so that the information is kept confidential from the service provider 15. In other embodiments, one or both of the authentication queries 30 and/or answers may be transmitted between the requesting party 10 and the service provider 15.

In response to receiving the answers to the authentication queries 30, the authentication provider 20 may be configured to compare the answers with the information provided in the replies 55 to determine a level of confidence in the identification of the requesting party 10. The authentication provider 20 may provide a confidence rating, authorization, and/or authentication certificate to the service provider 15.

In some embodiments, the authentication provider 20 may be configured to generate the authentication queries 30 in response to the initial request of the requesting party 10, and prior to contacting the third party service providers 40, 50, 60. The authentication queries 30 may comprise predetermined questions (and/or randomly determined questions) based on the identity of the requesting party 10 and/or the type of service associated with the service provider 15. The authentication provider 20 may obtain the authentication questions from a secure database. One or both of the authentication questions and the responses provided by the requesting party 10 may be encrypted.

The authentication provider 20 may transmit the answers to the authentication questions to the third party service providers 40, 50, 60, who may then compare the answers with information that they retain in confidence to verify the veracity of the response, before transmitting replies 55 to the authentication provider 20. The third party service providers 40, 50, 60 do not need to be informed of the nature of the transaction being requested by the requesting party 10 or the identity of the service provider 15 which is interacting with the requesting party 10. Accordingly, information associated with the transaction 5 and the authorization process may be kept isolated from each other.

The authentication provider 20 may be configured to determine a level of confidence in the identification of the requesting party 10 based on an analysis of the replies 55. The authentication provider 20 may then provide a confidence rating, authorization, and/or authentication certifying the identity of the requesting party 10 to the service provider 15. Upon receiving the confidence rating, authorization, and/or authentication certificate, the service provider 15 may determine to complete the transaction, e.g., to provide the requested information, merchandise, money, and/or service to the requesting party 10.

An identification of the requesting party 10 may be provided directly to the authentication provider 20. The identification may comprise a government issued document, such as a passport or a driver's license, other types of identification, and/or any combination thereof. The authentication provider 20 may exchange one or more tokens and/or keys with the requesting party 10 and/or the third party service providers 40, 50, 60 before the transaction 5. In some embodiments, the tokens may be exchanged in response to receiving the identification.

In the second stage of the authentication process, the tokens may be used to authenticate the identity of the requesting party 10 during the transaction 5. In some embodiments, the identity remains confidential and/or anonymous; however, the service provider 15 may be able to confirm that the token is authentic, and therefore the party that provided the token is authorized to participate in the transaction 5.

A requesting party 10 may provide one or more tokens to the service provider 15 by some secure means a set of tokens. In some embodiments, the requesting party 10 may receive the one or more tokens from the service provider 15. The requesting party 10 may use a token to put data into a data repository in an account associated with the token. The service provider 15 may be configured to accept the data in response to authenticating the token. The identity of the requesting party who is submitting the data may remain anonymous during the transaction. Similarly, the requesting party 10 may later access and/or remove data from the data repository by presenting the token, again, anonymously.

In addition to authenticating individuals seeking access to a location, file, database, web site, and/or or other objects, and authentication provider 20 may be configured to assure that the requesting party 10 is connected with the intended object. In some embodiments, the requesting party 10, e.g., the user, may comprise a database seeking to identify and authenticate its connection with another database when connection is first established, on a per-access basis, an ad-hoc basis, at the time connection is first established or whenever reestablished, and/or under any other condition. The authenticated connections may be made between two or more users, databases, web sites, programs, and/or any other electronic entity. Additionally, the authentication provider 20 may be configured to provide secure identification and authentication of any non-human object to which a user may be seeking interaction.

The authentication provider 20 may be configured to authenticate the target (e.g., the data source) of the inquiry at the same time that the requesting party 10 is authenticated. The target may comprise a company, a computer process, a database, a system of databases, another user, other entities, and/or any combination thereof. Additionally, the authentication provider 20 may be configured to evaluate the capability of one or more targets to provide data to the requesting party 10.

In addition to using known data to authenticate the requesting party 10 and/or the connection with one or more targets, the authentication provider 20 may be configured to use credentials to establish an identity of the requesting party 10 and/or the one or more targets. The credentials may be provided by an agency to vouch for the identity, security level, description, and/or other type of identification associated with an agent. For example, a government agency may present certifying information for a soldier with a particular security classification level and job description. In the case where an identity of the requesting party 10 and/or one or more of the targets is to remain confidential or anonymous, the credentials may certify that the requesting party 10 is authorized to request, access, and/or receive the requested information, even though the identity of the requesting party 10 may not be disclosed.

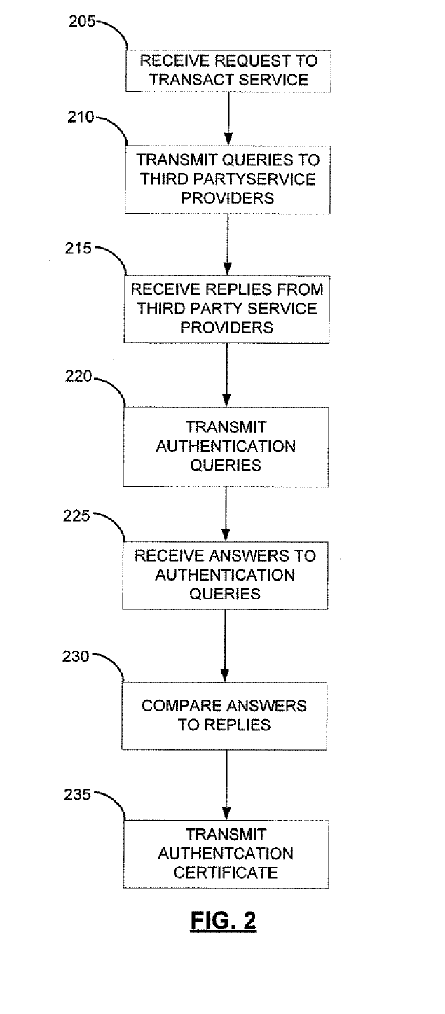

FIG. 2 illustrates a process 200 of authentication. At operation 205, a request for services is received from a requesting party. The request may comprise a request to register with a service provider in order to receive information, merchandise, money, and/or services from the service provider. The request may include an identity, level of access, account number, and/or other type of identifier associated with the requesting party that may be used for authentication purposes.

At operation 210, one or more queries are transmitted to one or more third party service providers. In some examples, the queries may be transmitted from an authorization provider to the one or more third party service providers. The queries may include requests for confidential information associated with the requesting party. In some embodiments, the queries may include, or be based on, information provided by the requesting party.

At operation 215, one or more replies to the queries are received from the third party service providers. The replies may comprise answers to the queries. In some embodiments, the replies may include a confidence rating or an authentication result.

At operation 220, one or more authentication queries are transmitted to the requesting party and/or to the service provider. The authentication queries may comprise questions associated with information included in the replies received from the third party service providers. For example, the authentication queries may comprise questions that request an answer that correlates with the confidential information provided by the third part service providers, that only the requesting party would also know.

At operation 225, one or more answers to the authentication queries are received from the requesting party and/or from the service provider. The answers may be encrypted in order to maintain confidentiality of information associated with the requesting party.

At operation 230, the requesting party's answers are compared to information included in the replies received from the third party service providers. The identity of the requesting party may be authenticated if the information provided in the requesting party's answers shares a high correlation with the information provided in the replies from the third party service providers. In some examples, the answers may be sent to the third party service providers for authentication of the answers as as valid responses. In other words the third party service provider may have sent only a question (for passing on to the requesting party) to the authentications service or may have sent both a question and the allowed responses. If the third party service provider sent only a question, the response to that question, as received by the authentication provider from the requesting party, may be confirmed with the third party provider.

At operation 235, an authentication certificate, or token, may be transmitted to the requesting party. The authentication certificate may include an authorization to conduct the transaction with the service provider. In some embodiments, the authentication certificate may comprise a confidence rating or score that may be used by the service provider to independently determine if the transaction with the requesting party should be completed.

In addition to authenticating the identity of the requesting party, a service provider may also want to control the distribution of secure information to the requesting party. For example, the service provider may want to establish that the requesting party is capable and/or authorized to perform the requested transaction. In some examples, the requesting party may be associated with a particular level of access and/or security rights.

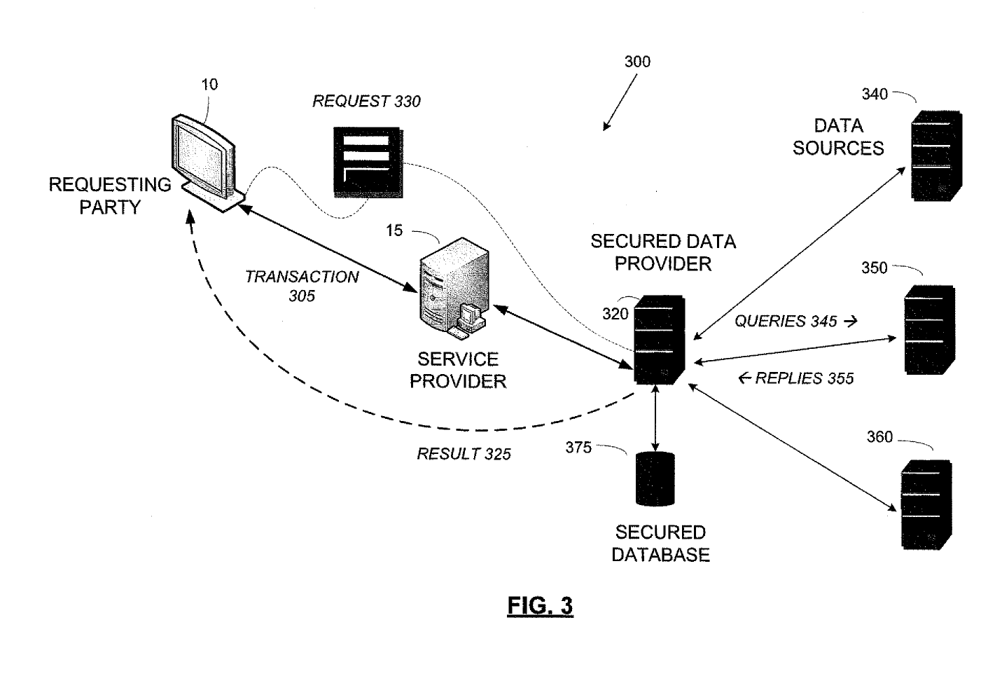

FIG. 3 illustrates an example system 300 that may be used for providing secure information to a requesting party 10. The requesting party 10 may be the same requesting party as discussed with reference to FIG. 1. Similarly, the requesting party 10 may request a transaction 305 with the same service provider 15 as discussed with reference to FIG. 1. In some embodiments, the transaction 305 may be conducted, at least in part, over the Internet; however, the transaction may also be conducted over other types of public and/or private networks, including any combination of wired and wireless networks.

The service provider 15 may act as an intermediary party between the requesting party 10 and a secured data provider 320. For example, the service provider 15 may contract with the secured data provider 320 to exchange information, merchandise, money, and/or services between the requesting party 10 and the secured data provider 320. In some embodiments, the service provider 15 may contract with the secure data provider 320 to get information on behalf of the requesting party 10 from the secure data provider 320. The secure data provider 320 may know nothing about the requesting party 10, and in some examples the secure date provider 320 may not know anything about the requesting party 10. In other embodiments, the service provider 15 may be integral, or combined, with the secured data provider 320, such that one entity performs functions associated with both the service provider 15 and the secured data provider 320.

The requesting party 10 may transmit a request 330 for information as part of transaction 305. The transaction 305 may be conducted between the requesting party, 10, the service provider 15, and/or the secured data provider 320. The secured data provider 320 may receive the request 330 from the service provider 15 and/or from the requesting party 10. In some embodiments, the secured data provider 320 may receive the request 330 directly from the requesting party 10.

The request 330 may comprise one or more data fields including, but not limited to, an identity of the requesting party 10, a password, a token, a search term, a key word, a designation of one or more of data sources, a response to an authentication query, an identity of the service provider 15, an authorization level of the requesting party, and/or other information associated with the transaction 305.

The secured data provider 320 may be configured to identify and/or authenticate a number of data sources associated with the request 330. For example, the secured data provider 320 may identify one or more of data sources 340, 350, and/or 360, referred to hereafter as data sources 340, 350, 360, communicatively coupled to the secured data provider 320. In some examples, an authentication provider may be used to authenticate the data sources.

Additionally, the secured data provider 320 may be configured to transmit one or more queries 345, referred to hereafter as queries 345, to the data sources 340, 350, 360 based, at least in part, on the information being requested. The queries 345 may be negotiated individually with data sources 340, 350, and/or 360. In some embodiments, the queries 345 may be negotiated prior to receiving the request 330. In some embodiments, the queries 345 may be transmitted anonymously to the data sources 340, 350, 360, without identifying the requesting party 10. The queries 345 may be licensed by operators of the data sources 340, 350, 360 for a specific use.

The type and nature of the queries 345 transmitted to the data sources 340, 350, 360 may be controlled to restrict and/or limit access to confidential information stored by the data sources 340, 350, 360. In some embodiments, the data sources 340, 350, 360 may provide the secured data provider 320 with predetermined queries. Access to the data sources 340, 350, 360 may be controlled according to an authorization level associated with the requesting party 10.

The secure data provider 320 may be configured to receive one or more replies 355 to the queries 345. The one or more replies 355, referred to hereafter as replies 355, may comprise data, information, and/or responses to the queries 345. In some embodiments, the replies 355 may comprise data, information, and/or responses to information included in the request.

Additionally, the secure data provider 320 may be configured to determine an authorization level associated with the requesting party 5. The replies 355 may be modified based, at least in part, on the authorization level of the requesting party 5. The replies 355 may be modified by filtering out confidential information and/or filtering out information that is designated as being a higher security level than authorized for the requesting party 5. In some embodiments, the replies 355 may be modified by aggregating information contained in a plurality of replies.

The replies 355 may be modified, filtered, aggregated, combined and/or otherwise processed to generate a result 325. The secured data provider 320 may be configured to transmit the modified replies and/or the result 325 to the requesting party 10. In some embodiments, the result 325 may be transmitted directly to the requesting party 10 from the secured data provider 320 in order to maintain confidentiality of the information contained in the replies 355.

The secured data provider 320 may be associated with, and/or operatively connected to, a secured database 375. The secured database 375 may be configured to store confidential information related to the requesting party 10 and other requesting parties. The confidential information may comprise passwords, login information, personal information, financial information, security access, authorization level, identification number, account information, and/or other information associated with the requesting party 10 and/or the data sources 340, 350, 360.

Information included in the replies 355 and/or in the secured database 375 may be kept confidential from the service provider 15. In some embodiments, the service provider 15 simply provides a gateway to the secured data provider 320.

The identity of the requesting party 10 and the data sources which are accessed by the secured data provider 320 may vary widely. Examples of the data sources 340, 350, 360 include VISANET, the Social Security Administration, the Internal Revenue Service, various of the national credit bureaus, national telephone directory services, the Department of Motor Vehicles, etc.

The secured data provider 320 may be configured to provide access to multiple “stove-piped” data sources, that is, data sources which do not communicate or share information with each other. The secured data provider 320 may act like a gatekeeper to avoid cross-system data exposure between the data sources 340, 350, 360. Additionally, the secured data provider 320 may act as a confidential aggregator of information provided by the data sources 340, 350, 360 in order to provide a single, composite result from the compilation of data. Access to the data may be controlled in order to provide multiple layers and levels of authentication and/or security authorization. Because there are multiple ways to establish identity and/or access information, and because the information may be stored in multiple unrelated databases, it becomes extremely difficult for an identity thief or other criminal to obtain access to the data.

In addition to authenticating the requesting party 10, authenticating the data sources 340, and/or authenticating information included in the replies 355, the secured data provider 320 may be configured to authenticate a document, a process, an individual, a company, and other entities and/or items. For example, the secured data provider 320 may be configured to authenticate that a document is an original document by exchanging information with multiple data sources in order to confirm the original content of the document, the signature data, etc. In another example, the secured data provider 320 may be configured to authenticate a process or service being provided, such as a loan approval, a bank transaction, a purchase, a connection to secure databases, a sequence in a series of menu selections, etc. The secured data provider 320 may be configured to perform some or all of the operations described with respect to the authentication provider 20 in FIG. 1, and some or all of the operations described with respect to FIG. 2. In some embodiments, the service provider 15 may be configured to perform some or all of the operations described with respect to the authentication provider 20 in FIG. 1, and some or all of the operations described with respect to FIG. 2.

Pre-established connections with the secured data provider 320 and/or the data sources 340, 250, 260 may be used to obtain confidential information related to the requesting party 10, such as establishing the identity of the requesting party 10, obtaining passwords, establishing levels of security demanded by a particular data source, and other information that may be used during the transaction 305. The pre-established connections may be made by a first party prior to the request for information, such as during a registration process. The first party may be identified as the requesting party 10 once the request for information has been made. Additionally, connections from the requesting party 10 may be controlled based on previously provided passwords and other information obtained during the pre-established connections in order to facilitate the transaction 305.

The confidentiality of the requesting party, the service provider, and/or the data sources may be maintained before, during, and after the transaction. The authentication of a party's ability to conduct the transaction may be made without necessarily knowing the identity of the party. Similarly, some or all of the information transmitted before, during, and/or after the transaction may be made via one or more secured communication channels. The overall system structure may be configured to maintain the confidentiality of the parties.

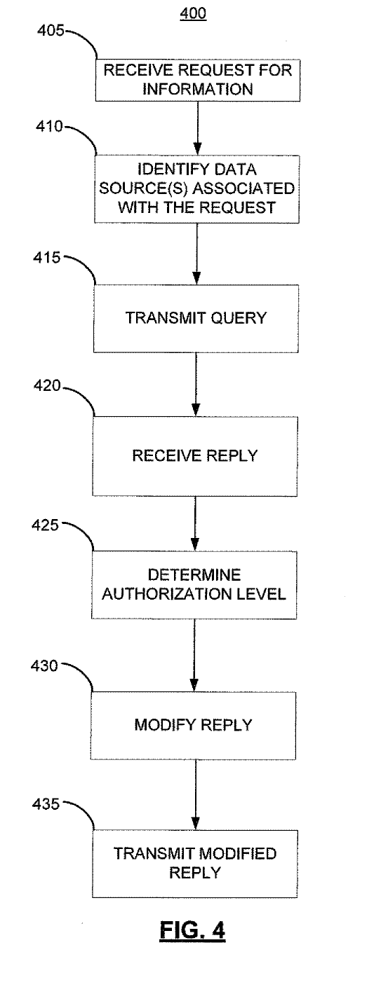

FIG. 4 illustrates a process 400 of providing secure information to a requesting party. At operation 405, a request for information is received.

At operation 410 one or more data sources associated with the request are identified. In some embodiments, the request may include an identity of the requesting party.

At operation 415, a query is transmitted to the one or more data sources based, at least in part, on the information being requested. The query may be negotiated with the one or more data sources. In some embodiments, the query may be negotiated with the one or more data sources prior to receiving the request for information. The query may be transmitted anonymously to the one or more data sources, without identifying the requesting party.

The query and/or queries may be licensed with the one or more data sources. The licensed queries may limit the type and scope of query that may be submitted, thereby reducing the likelihood of a party making an unauthorized data dump of a database, for example. The licensing of the queries may be done on a database level, where only the license queries can be asked of this database by a requesting party. Additionally, the licensing may be done on a person by person level, where a particular person's access to a database is restricted to the licensed queries. A second person may be associated with a different set of licensed queries. In some embodiments, the licensed queries may be based on a job by job level, where the requesting party is provided with temporary licenses until the job is completed and/or until the queries have been used.

The licensed queries can be pre-existing between the service provider and the databases. The licensed queries may be available to any requesting party who is authenticated and/or to those requesting parties who have been provided with a registered token. The token may be provided by the trusted authenticator to the requesting party and then employed by the requesting party to access the entire system or to access one or more database in the system, all in suitably encrypted form.

At operation 420, one or more replies to the query are received from the one or more data sources. In some embodiments, the identity of the requesting party may be authenticated based, at least in part, on a comparison between the information being requested and a reply to the query.

At operation 425, an authorization level associated with the requesting party is determined. More than one authorization level may be associated with the requesting party. For example, an authorization level may be based on the level of security associated with the requesting party. Additionally, an authorization level may be based on a specific task or job description, for example where the requesting party has a need to know confidential information on a one time basis.

At operation 430, the one or more replies are modified based, at least in part, on the authorization level of the requesting party. A reply may be modified by filtering out confidential information from the reply. In some embodiment, the reply may be modified by aggregating a plurality of replies received from more than one of the data sources. While the queries themselves may be controlled by the licensing, the information provided in response to the queries may be monitor and/or modified. For example, highly classified data may be assembled from low classified data sources, or low classified data may be assembled from highly classified data sources.

At operation 435, the modified reply is transmitted to the requesting party. In some embodiments, a memory device has instructions stored thereon that, in response to execution by a processing core, cause the processing core to perform operations disclosed in FIG. 4. Additional systems and methods of providing data transactions are disclosed in U.S. application Ser. No. 13,230,471, the specification of which is herein incorporated by reference in its entirety.

Once the authentication provider establishes the bonafides of the requesting party and/or the third party service providers, the authentication provider may decide what communications are allowed among the parties, preserve the anonymity of the various parties from each other, monitor what is transmitted, and/or perform other operations. The authentication provider may be configured to authenticate both parties, filter what can pass between the parties, and provide for an anonymous transaction to preserve the confidentiality of each party's identity.

As an example, a first party has the need to ship something (physical or electronic) to a second party, though neither party knows of the other nor can they be allowed to know the identity of the other party. The first party loads an anonymous truck with a shipment labeled only with a barcode, and the shipment is taken to a warehouse. The authentication provider, for example located at the warehouse, authenticates where that shipment is supposed to go, removes the first bar code, applies another that will authenticate the first party without identifying it to the second party, puts it in another anonymous truck and sends it to the second party who then scans the bar code and receives the authenticated shipment. In some examples, the authentication provider may be provided access to a database that says the a shipment with a particular serial number needs to have the address associated with the authentication provider removed, and the final delivery address associated with the second party attached to the shipment.

By way of further illustration, three examples of systems for providing secured data access are provided below, including protected access to multiple sites, anonymous data collection, and restricted access of confidential information.

Protected Access to Multiple Sites Example

For systems that include multiple connected databases which operatively communicate with each other, a single user may gain access to some or all of the databases. However, this type of data structure may be particularly susceptible to fraudulent access or cyber attacks of the entire data structure even if access to only a single database is initially provided. Accordingly, the ease of access also introduces inherent risk of data compromise. On the other hand, organizations (including governmental agencies) which utilize multiple databases which are not connected together, are stove-piped, and/or are maintained separately, make it difficult for a user to coordinate access, compare data, and/or compile data which may exist in multiple databases, but which are nevertheless related, or may be related, to provide a response to a query. As a result, important information that may only be possible to obtain and/or understand through access to more than one database may be missed or overlooked if the databases are stove-piped.

By providing secured access to a plurality of databases, a secured data provider may control access at the individual and query levels based, in part, on an authentication of the requesting party. Any data that is aggregated may be done by the secured data provider in a controlled manner. Similarly, access to one or more databases may be restricted altogether depending on the identification and/or authorization level associated with the requesting party. Accordingly, there is no need for the databases (or the entities who control the databases) to aggregate the information themselves. Control of the data and its dissemination may remain with the entity which maintains the databases based, at least in part, on the negotiated queries with the secured data provider.

Additionally, a user who lacks the proper authorization level may be prohibited from obtaining a comprehensive download (i.e., data dump) of the contents of multiple connected databases. For example, a user may be allowed to request the query: “Give me security information relevant to USS Cole attack” but would be prohibited from requesting the query: “Give me all Yemeni security information”. Accordingly, access to one or more of the multiple databases may be tailored to the individual requesting the data, such that the information may be provided on a restricted, or need-to-know, basis.

The system may also prevent the data from becoming obsolete, since the data will continue to reside with the original sources of the data that are able to maintain the integrity of the data, until the data is provided to the requesting party. Controlled access to the databases may be provided while allowing them to continue to operate independently of each other and, in some cases, unaware of the existence of the other databases.

Anonymous Data Collection Example

Medical research often relies upon data collected from a relatively large population of patients; however governmental regulations frequently prohibit the release of personal information related to the patients, including their identity. Accordingly, compiling data for medical research can be fairly laborious. In some cases, databases which contain the confidential information may simply prohibit access by any third parties. Take, for example, a requesting party who wants to conduct research on the incidence of brain cancer near power lines. Information which may be helpful to identify a correlation may include the type of cancer that is contracted, the exposure duration, and contributing demographic factors.

In the present example, three databases include information which may be helpful in the research, including: a first database storing patient records (including patient names and addresses), a second database storing the physical location and operating history of power lines, and a third database storing Geo-positional information which may be used to link the residential addresses of the patients with the physical location of the power lines.

Based on the patient privacy laws and concerns, access to the patient records including the individual patient identity and residential address must be protected. Furthermore, the identity of the patients may be irrelevant to the research. However, the type of cancer and timing of when the cancer was contracted may be essential to the research.

Similarly, information on who owns a particular power line (e.g., the power line operator), may be deemed sensitive, such that the owner may be inclined not to participate or assist in the research if bad publicity would result. Furthermore, the identity of the owner of the power line may be irrelevant to the research. Providing the geographic location of the power lines would likely serve to identify the owners, which may not be desirable. However, the electrical load carried by the power line, operational history, and other technical specifications may be essential to the research.

Authentication of the researcher and/or databases (e.g., power companies) may be made using one or more of the methods discussed above. Such authentication may be made separately, and/or prior to, any request for information made by the researcher.

The researcher may submit a request to the secured data provider for all incidents of brain cancer within one mile of any operating power line, including the duration and intensity of the exposure. The secured data provider may send separate inquiries to each of the three databases, and received three separate responses. In some embodiment, the queries may be sent at different times, such that a response to a first query may be used to generate a second query. For example, the secured data provider may identify a zip code associated with one or more of the patients, and then send a query to a power company for all power lines located in that zip code. Accordingly, the information requested in the query may be limited to the relevant information being sought, while protecting the identity of all parties.

The secured data provider may be configured to correlate data provided by two or more of the databases. For example, the secured data provider may be configured to associate a residential address with a geopositional location using data from two or more databases. Additionally, the secured data provider may be configured to remove and/or filter out information related to the names and residential information of the patients, as well as the power companies who own and/or operate the power lines.

The aggregated and/or correlated data may be stored, e.g., temporarily, in a secured database. Additionally, the aggregated and/or correlated data may be transmitted to the researcher without the personal and/or confidential information included. The personal and/or confidential information stored in the secured database may be purged so that the information is not retained after the queries have been processed.

Restricted Access of Confidential Information Example

In this example, a soldier in the field captures a cell phone from suspect and, for purposes of interrogation, needs to know the identity of individuals in a call log, in addition to the relationships among an address list and the individuals in the call log.

Portions of the requested data exist in a plurality of separately-maintained databases of different security levels. For example, a first database may include persons of interest and their phone numbers (lowest security level). A second database may identify how the persons of interest are linked together and/or how they are associated with each other (highest security level).

There are various concerns over privacy as well as protection. For example, the soldier must not be able to do data dumps or to access data beyond his clearance level. At the same time, the soldier must be able to access the high-security databases to determine what needs to be done with the cell phone information, but without actually being provided the restricted data. The soldier may be at risk of capture and could compromise any data that he obtains, thereby placing a premium on providing information on a need-to-know basis.

As in other examples, the identity and/or clearance level of the soldier and/or databases may be authorized, or in some cases pre-authorized. The secured data provider may have predetermined queries, or may negotiate queries, which identify what data may be released based on the identity and/or clearance level of the soldier. Similarly, the queries may be used to identify what data may be accessed by the secured data provider in order to respond to the request for information, while further restricting the release of the data by the secured data provider.

The soldier may supply information, such as the names and phone numbers in the cell phone, to the secured data provider. The information may be encrypted. The secured data provider may transmit a first query to the first database in order to determine if there is a relationship between persons of interest and the phone list obtained from the cell phone. Additionally, the secured data provider may transmit a second query to the second database in order to determine how one or more of the persons of interest may be associated. Based on an analysis of the results, the secured data provider may transmit a response to the soldier to assist in decisions made on the field.

Some or all of the results to the inquiries may be stored in a temporary secured database, e.g., for processing. Information provided by the soldier may be used to fill in any gaps of information maintained by the first database and/or the second database.

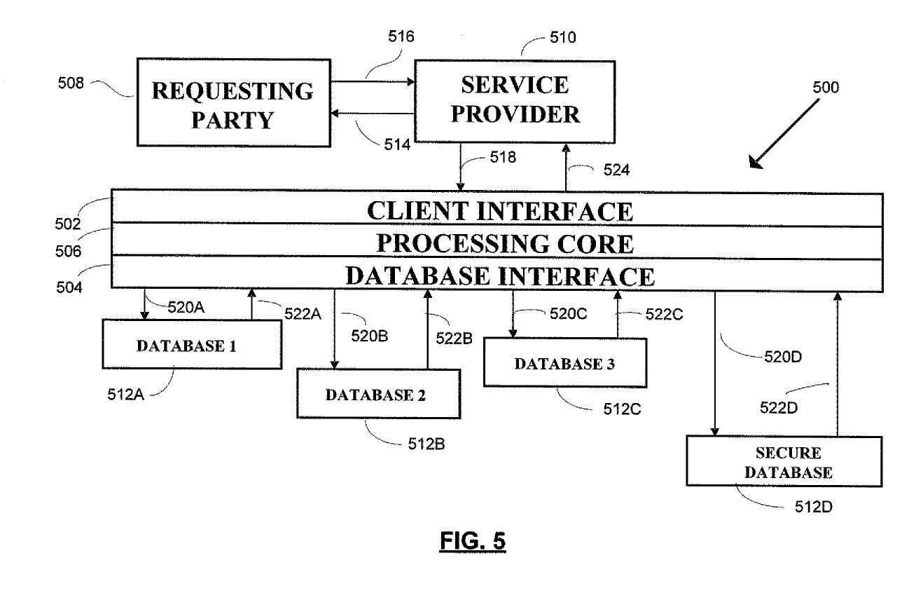

FIG. 5 illustrates a system 500 configured to provide secure information to a requesting party 508. The system 500 may comprise a client interface 502, a database interface 504 and a processing core 506. One or more apparatus may be configured to perform some all of the functions described with reference to the system 500. In some embodiments, the system 500 may comprise software, programming code, and/or instructions stored on one or more memory devices and/or computer-readable media. For example, the client interface 502, the processing core 506 and/or the database interface 504 may comprise software modules and/or application programming interfaces (API) that perform some or all of the operations described with reference to the system 500.

The service provider 510 may act as an intermediary party between the requesting party 508 and the system 500. For example, the service provider 510 may contract with the system 500 to provide a secure data transaction, including the exchange of information, merchandise, money, and/or service between the requesting party 508 and the system 500. In other embodiments, the service provider 510 may be integral, or combined, with the system 500, such that one entity performs functions associated with both the service provider 510 and the system 500 including, but not limited to, an authentication of the requesting party 508 and one or more databases, such as databases 512A, 512B, 512C, and/or 512D.

The client interface 502 may be configured to interface with the requesting party 508 and/or the service provider 510. In some embodiments, the client interface may provide a single interface, with a single set of commands, to all system requesting parties, such as requesting party 508, in order control access to the secure data system including the one or more databases 512A, 512B, 512C, and/or 512D, referred to hereafter as databases 512A, 512B, 512C, 512D.

The client interface 502 may be configured to receive a request for information. The request may be associated with the requesting party 508, such as a request 516 transmitted by the requesting party 508. In some embodiments, a request 518 may be received from the service provider 510, for example the service provider 510 may forward the request 516 to the system 500. Similarly, the client interface 502 may be configured to communicate with the requesting party 508 and/or the service provider 510 as part of an authentication process.

The processing core 506 which may be operatively connected with the client interface 502 as well as a database interface 504. The processing core 506 may be configured to process the request for information and to determine and/or generate one or more related queries that may be transmitted to the databases 512A, 512B, 512C, 512D. The queries it can present, as discussed in detail below, can be tailored to the particular needs of a specific client. In some examples, processing core 506 may be configured to control the licensing of queries asked, translation of formats in both directions, and aggregation of responses from the databases 512A, 512B, 512C, 512D.

The system 500 may comprise, and/or be operatively connected with, a secure database 512D. The secure database 512D may be configured to store confidential information related to the requesting party 508, the service provider 510, and one or more of databases 512A, 512B, and/or 512C. For example, the secure database 512D may store passwords, login information, personal information, financial information, security access, authorization level, identification number, account information, and/or other information associated with the requesting party 508 and/or databases 512A, 512B, 512C. In some embodiments, the secure database 512D may be configured to store predetermined and/or negotiated queries.

The processing core 506 core may be configured to determine the queries based on knowledge about what each connected database has the ability to answer, how likely the database is to provide an answer, how long it generally takes for the database to provide the answer, and/or other criteria associated with the databases 512A, 512B, 512C. The processing core 506 may obtain the database knowledge through collaboration with independent database operators to develop the specific queries that will be allowed for use in the secure data transaction.

The database interface 504 may be configured to transmit a query to one or more of the databases 512A, 512B, 512C, 512D based, at least in part, on the information being requested. For example, a first query 520A may be transmitted to a first database 512A, a second query 520B may be transmitted to a second database 512B, and/or a third query 520C may be transmitted to a third database 512C. A query may be transmitted anonymously to the one or more of the databases 512A, 512B, 512C, without identifying the requesting party 508.

The database interface 504 is configured to interface with databases 512A, 512B, 512C, 512D, using the protocol and programming language associated with each respective database, both for querying and for receiving back the replies to the queries. For example, a first reply 522A may be received from the first database 512A, a second reply 522B may be received from the second database 512B, and/or a third reply 522C may be received from the third database 512C.

The client interface 502 and/or the database interface 504 may comprise a device configured to transmit and/or receive information. In some embodiments, one or both of the client interface 502 and the database interface 504 may comprise a network device and/or a wireless device. For example, the client interface 502 and/or the database interface 504 may comprise a transponder, a router, a modem, a network card, a hub, a switch, a gateway, other types of communication devices, and/or any combination thereof.

In some embodiments, the secure database 512D may be configured to store the replies from the databases 512A, 512B, 512C, at least temporarily, while the processing core 506 operates on the data in the replies. One or more of the replies 522A, 522B, and/or 522C may be stored 520D in the secure database 512D, and then retrieved 522D so that it can be operated on by the processing core 506. The processing core 506 may be configured to modify a reply to the query based, at least in part, on an authorization level associated with the requesting party 508. The reply may be modified by filtering out confidential information from the reply. In some embodiments, the reply may be modified by aggregating a plurality of replies 522A, 522B, 522C received from more than one of the databases 512A, 512B, 512C. For example, the processing core 506 may be configured to assemble the replies from various independent databases into a coordinated response to the requesting party 508.

The processing core 506 may be configured to manage multiple passwords of the requesting party 508 in order to establish different levels of security associated with the databases 512A, 512B, 512C. One or more of the queries 520A, 520B, 520C may be negotiated with the databases 512A, 512B, 512C based, at least in part, on an authorization level associated with the requesting party 508. In addition to passwords, the processing core 506 may be configured to manage licenses provided to the user for specific queries. In some examples, the licenses may be generated by the processing core 506 on a database-by-database, or query-by-query, basis. The licenses may be based on information passed to the processing core 506 from the user and/or a secured data provider.

The user may receive a token that identifies the kind of questions the user is allowed to ask the overall system. The token, along with a query, may be passed to the processing core 506. In response to receiving the query, the processing core 506 may break the query apart into the pieces the individual databases can handle. Additionally, the processing core 506 may create a new licensed token for each database, certifying that the user is authorized to submit the query. Accordingly, both the processing core 506 and the databases 512A, 512B, 512C may be configured to determine whether the query fragment being asked is legitimate without the databases 512A, 512B, 512C having to know anything about the requesting user.

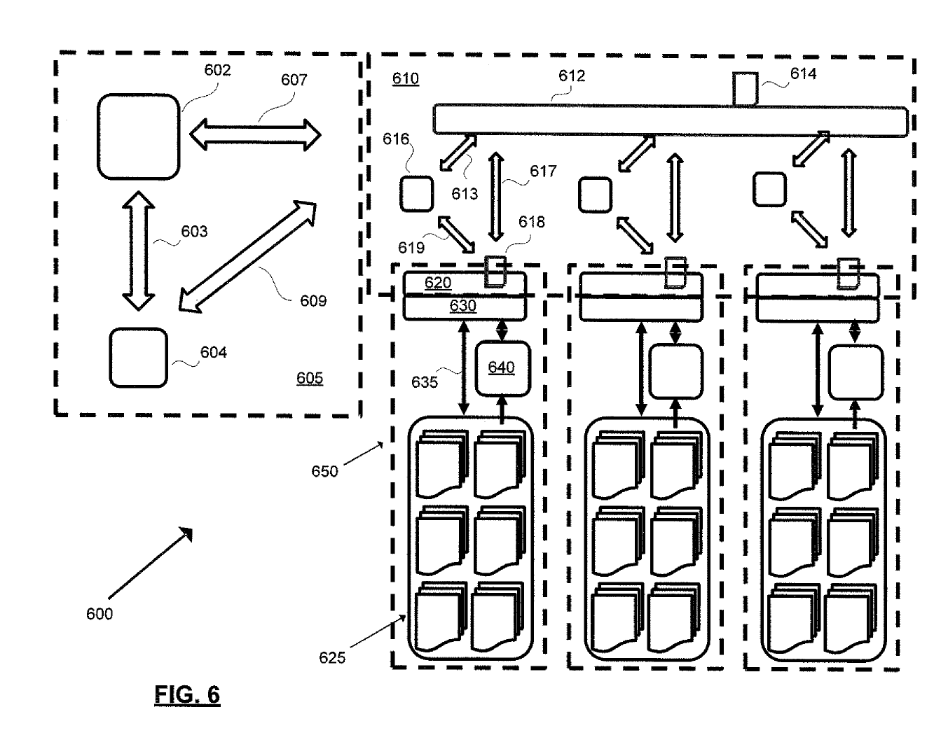

FIG. 6 illustrates a system 600 configured to provide both authentication services and secure information transaction services. System 600 may comprise an authentication system 605, a data transaction system 610, and one or more data systems, such as data system 650.

The authentication system 605 may be configured to provide similar services as those described with respect to the system 100 of FIG. 1. For example, an authentication provider 602 may be configured to authenticate a requesting party 604 via communication and/or a transaction 603 with the requesting party 604, as well as via communication and/or one or more queries 607 made to a third party service provider and/or one or more data sources. The transaction 603 may comprise a request for data. Additionally, authentication may be based, at least in part, on a transfer of information 609, which may include pre-certification, between the requesting party 604 and the third party service provider and/or the one or more data sources. In some embodiments, the transfer of information 609 may occur prior to the transaction 603.

The authentication system 605 may interface with the data transaction system 610 in order to combine the authentication services associated with authentication system 605 with secure data transaction services provided by the data transaction system 610. In some embodiments, the data transaction system 610 may be configured to provide similar services as those described with respect to the system 300 of FIG. 3.

Data transaction system 610 may comprise a query manager 612, one or more authentication providers, such as authentication provider 616, and one or more database transaction managers, such as database transaction manager 620. The query manager 612 may be configured to negotiate, license, control, monitor, generate, and/or otherwise manage a set of queries 614 with the authentication system 605. For example, the queries 614 may comprise a number of predetermined and/or licensed queries that the authentication system 605 is permitted and/or authorized to transmit to the data transaction system 610. The queries 614 may be transmitted from the authentication provider 602 and/or identified via communications from the authentication provider 602.

Authentication provider 616 may be configured to provide authentication services associated with one or more data sources, such as database 625 of data system 650. In some embodiments, a set of query parameters 618 may be associated with the data system 650, and the query parameters 618 may be configured to control the communications 619 transmitted between the authentication provider 616 and the data system 650 and/or to control a secure data transaction 617 transmitted between the data system 650 and the query manager 612. Communications, requests, and/or queries, based on the query parameters 618, may be transmitted in response to verification that the database 625 and/or data system 650 has been authenticated. The authentication 613 may be transmitted to the query manager 612 prior to, and/or as part of, the secure data transaction 617.

The database transaction manager 620 may be associated with, and/or be part of, a database translation layer existing at the communication boundary between the data transaction system 610 and the data system 650. The database translation layer may comprise the database transaction manager 620 and a language component 630. The database transaction manager 620 may be configured to translate a language associated with the data transaction system 610 with the language component 630 of the data source 650. In some embodiments, different databases may operate using different languages and/or language components, and the data source 650 may comprise a different database transaction manager for each data source.

Queries received as part of the transaction 617 may be translated into, modified as, and/or cause to be transmitted, a request 635 that is send to the database 625. The request 635 may comprise a query, a question, an account number, a command, another type of communication, and/or any combination thereof. Data source 650 may comprise a buffer 640 configured to store one or more responses to the request. Information contained in the buffer 640 may be modified, aggregated, redacted, and/or otherwise modified before it is transmitted to the data transaction system 610.

As illustrated in FIG. 6, the requesting party 604 and the database 625 may each be separately authenticated by one or more authentication providers, such as authentication provider 602 and authentication provider 616, as part of a secure data transaction. The data transaction system 610 may, after receiving confirmation of the authenticated parties, then proceed to transfer information between the requesting party 604 and the database 625, without either party having to directly authenticate each other or, for that matter, having to know the identity of each other. Accordingly, the system 600 illustrates an example embodiment of a secure and confidential data transaction.

The system and apparatus described above may use dedicated processor systems, processing devices, microcontrollers, programmable logic devices, microprocessors, or any combination thereof, to perform some or all of the operations described herein. Some of the operations described above may be implemented in software and other operations may be implemented in hardware. One or more of the operations, processes, and/or methods described herein may be performed by an apparatus, a device, and/or a system substantially similar to those as described herein and with reference to one or more of the illustrated FIGS. 1 to 5.

The processing core may execute instructions or “code” stored in memory. The memory may store data as well. The processing core may include, but may not be limited to, an analog processor, a digital processor, a microprocessor, a multi-core processor, a processor array, a network processor, or the like. The processing core may be part of an integrated control system or system manager, or may be provided as a portable electronic device that may be configured to interface with a networked system, locally and/or remotely, via a wireless transmission.

The processor memory may be integrated together with the processing core, for example RAM or FLASH memory disposed within an integrated circuit microprocessor or the like. In other examples, the memory may comprise an independent device, such as an external disk drive, a storage array, a portable FLASH key fob, or the like. The memory and processing core may be operatively coupled together, or in communication with each other, for example by an I/O port, a network connection, or the like, and the processing core may read a file stored on the memory. Associated memory may be “read only” by design (ROM) by virtue of permission settings, or not. Other examples of memory may include, but may not be limited to, EPROM, EEPROM, FLASH, or the like, which may be implemented in solid state semiconductor devices. Other memories may comprise moving parts, such as a known rotating disk drive. All such memories may be “machine-readable” and may be readable by a processing core.

Operating instructions or commands may be implemented or embodied in tangible forms of stored computer software (also known as “computer program” or “code”). Programs, or code, may be stored in a digital memory and may be read by the processing core. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long as the stored information may be “read” by an appropriate processing core. The term “computer-readable” may not be limited to the historical usage of “computer” to imply a complete mainframe, mini-computer, desktop or even laptop computer. Rather, “computer-readable” may comprise storage medium that may be readable by a processor, a processing core, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

Having described and illustrated the principles of various examples, it should be apparent that the examples may be modified in arrangement and detail without departing from such principles. We claim all modifications and variations coming within the spirit and scope of the following claims.

1. A method, comprising:
receiving a request for information;
identifying, by a processing core, one or more data sources associated with the request;
transmitting a query to the one or more data sources based, at least in part, on the information being requested, wherein the query is negotiated with the one or more data sources;
receiving a response to the query from the one or more data sources;
determining, by the processing core, an authorization level associated with the requesting party;
modifying, by the processing core, the response based, at least in part, on the authorization level of the requesting party; and
transmitting the modified response to the requesting party.

2. The method of claim 1, wherein the request includes an identity of the requesting party, and wherein the method further comprises authenticating, by the processing core, the identity of the requesting party based, at least in part, on a comparison between the information being requested and the response to the query.

3. The method of claim 1, wherein the query is negotiated with the one or more data sources prior to receiving the request for information.

4. The method of claim 1, wherein the query is transmitted anonymously to the one or more data sources, without identifying the requesting party.

5. The method of claim 1, wherein modifying the response comprises filtering out confidential information from the response.

6. The method of claim 1, wherein modifying the response comprises aggregating a plurality of replies received from more than one of the data sources.

7. The method of claim 1, wherein the response includes an identity of the one or more data sources, and wherein the method further comprises authenticating, by the processing core, the identity of the one or more data sources based, at least in part, on a comparison between the information being requested and the response to the query.

8. A memory device having instructions stored thereon that, in response to execution by a processing core, cause the processing core to perform operations comprising:
receiving a request for information;
identifying a plurality of data sources associated with the request;
transmitting one or more queries to the plurality of data sources based, at least in part, on the information being requested, wherein the one or more queries are negotiated with the plurality of data sources;
receiving a plurality of replies to the one or more queries;
determining an authorization level associated with the requesting party;
modifying the plurality of replies based, at least in part, on the authorization level of the requesting party; and
transmitting the modified replies to the requesting party.

9. The memory device of claim 8, wherein the request includes an identity of the requesting party, and wherein the operations further comprise authenticating, the identity of the requesting party based, at least in part, on a comparison between the information being requested and the plurality of replies.

10. The memory device of claim 8, wherein the one or more queries are negotiated with the plurality of data sources prior to receiving the request for information.

11. The memory device of claim 8, wherein the one or more queries are transmitted anonymously to the plurality of data sources, without identifying the requesting party.

12. The memory device of claim 8, wherein modifying the plurality of replies comprises filtering out confidential information from the plurality of replies.

13. The memory device of claim 8, wherein modifying the plurality of replies comprises aggregating information contained in the plurality of replies.

14. A system, comprising
first means for authenticating a requesting party;
means for receiving a request for information, wherein the request is associated with the requesting party;
means for associating the request with one or more data sources;
second means for authenticating the one or more data sources;
means for transmitting a query to the one or more data sources based, at least in part, on the information being requested, wherein the query is negotiated with the one or more data sources; and
means for modifying a response to the query based, at least in part, on an authorization level associated with the requesting party, wherein the modified response is transmitted to the requesting party.

15. The system of claim 14, wherein the request is received from the requesting party, and wherein said first means for authenticating comprises means for authenticating an identity of the requesting party based, at least in part, on a comparison between the information being requested and the response to the query.

16. The system of claim 14, wherein the query is negotiated with the one or more data sources based, at least in part, on the authorization level associated with the requesting party.

17. The system of claim 14, wherein the query is transmitted anonymously to the one or more data sources, without identifying the requesting party.

18. The system of claim 14, wherein the second means for authenticating is independent from the first means for authenticating.

19. The system of claim 14, wherein the means for modifying comprises means for aggregating a plurality of replies received from more than one of the data sources.

20. The system of claim 19, wherein the means for modifying comprises means for managing multiple passwords of the requesting party in order to establish different levels of security associated with the more than one data sources.
